(19) United States
(12) Patent Application Publication
(10) Pub. No.: US 2021/0297915 A1
(43) Pub. Date: Sep. 23, 2021

(54) PACKET DATA CONVERGENCE PROTOCOL (PDCP) PROTOCOL DATA UNIT (PDU) HANDLING FOR MOBILITY BETWEEN NEW RADIO ACCESS TECHNOLOGY AND LONG TERM EVOLUTION

(71) Applicant: Nokia Technologies Oy

(72) Inventors: Guillaume DECARREAU, Munich (DE); Benoist Pierre SEBIRE, Tokyo (JP)

(21) Appl. No.: 16/321,788

(22) PCT Filed: Aug. 11, 2016
(86) PCT No.: PCT/US2016/046565

§ 371 Date: Jan. 29, 2019

(51) Int. Cl. H04W 36/14; H04W 36/02; H04L 12/801

(52) U.S. Cl. CPC H04W 36/14; H04L 47/34; H04W 36/023

(57) ABSTRACT

Systems, methods, apparatuses, and computer program products of signalling support for protocol data unit (PDU) handling for new radio (NR) to LTE handover are provided. One method includes, when handover from a new radio (NR) network to a long tem evolution (LTE) network is triggered, if a required sequence number (SN) space for the handover is not sufficient in LTE, then storing or queueing the protocol data units (PDUs) from the packet data convergence protocol (PDCP) packet data unit (PDU) transmission buffer of new radio (NR) in the PDCP service data unit (SDU) transmission buffer of LTE.

### BACKGROUND

### Field

Embodiments of the invention generally relate to wireless or mobile communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A), LTE-A Pro, and/or 5G radio access technology. Some embodiments may generally relate to handover between such networks.

### Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and radio access functionality is provided by an evolved Node B (eNodeB or eNB) or many eNBs. Multiple eNBs are involved for a single UE connection, for example, in case of Coordinated Multipoint Transmission (CoMP) and in dual connectivity.

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least, for example, 75 megabits per second (Mbps) per carrier and downlink peak rates of at least, for example, 300 Mbps per carrier. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and media transport in addition to high-capacity voice support. Advantages of LTE include, for example, high throughput, low latency, FDD and TDD support in the same platform, an improved end-user experience, and a simple architecture resulting in low operating costs.

Certain releases of 3GPP LTE (e.g., LTE Rel-10, LTE Rel-11, LTE Rel-12, LTE Rel-13) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while maintaining backward compatibility. One of the key features of LTE-A, introduced in LTE Rel-10, is carrier aggregation, which allows for increasing the data rates through aggregation of two or more LTE carriers.

5^{th} generation wireless systems (5G) refers to the new generation of radio systems and network architecture. 5G is expected to provide higher bitrates and coverage than the current LTE systems. Some estimate that 5G will provide bitrates one hundred times higher than LTE offers. 5G is also expected to increase network expandability up to hundreds of thousands of connections. The signal technology of 5G is anticipated to be improved for greater coverage as well as spectral and signaling efficiency.

### SUMMARY

One embodiment is directed to a method, when handover from a new radio (NR) network to a long term evolution (LTE) network is triggered, the method includes, if a required sequence number (SN) space for the handover is not sufficient in LTE, queueing the protocol data units (PDUs) from the packet data convergence protocol (PDCP) packet data unit (PDU) transmission buffer of new radio (NR) in the PDCP service data unit (SDU) transmission buffer of LTE. If the required sequence number (SN) space for the handover is sufficient, the method includes re-numbering the NR PDCP PDUs that need to be transmitted starting at 0 and storing the NR PDCP PDUs in the LTE PDCP transmission buffer. After the handover is completed, the method includes transmitting, by a transmitting entity, the NR PDCP PDU before transmitting any new PDCP SDU.

Another embodiment is directed to an apparatus including at least one processor and at least one memory including computer program code. When handover from a new radio (NR) network to a long term evolution (LTE) network is triggered, the at least one memory and computer program code are configured, with the at least one processor, to cause the apparatus at least to, if a required sequence number (SN) space for the handover is not sufficient in LTE, queue the protocol data units (PDUs) from the packet data convergence protocol (PDCP) packet data unit (PDU) transmission buffer of new radio (NR) in the PDCP service data unit (SDU) transmission buffer of LTE. If the required sequence number (SN) space for the handover is sufficient, the at least one memory and computer program code are configured, with the at least one processor, to cause the apparatus at least to re-number the NR PDCP PDUs that need to be transmitted starting at 0 and storing the NR PDCP PDUs in the LTE PDCP transmission buffer. After the handover is completed, the at least one memory and computer program code are configured, with the at least one processor, to cause the apparatus at least to transmit the NR PDCP PDU before transmitting any new PDCP SDU.

Another embodiment is directed to an apparatus including, when handover from a new radio (NR) network to a long term evolution (LTE) network is triggered, if a required sequence number (SN) space for the handover is not sufficient in LTE, means for queueing the protocol data units (PDUs) from the packet data convergence protocol (PDCP) packet data unit (PDU) transmission buffer of new radio (NR) in the PDCP service data unit (SDU) transmission buffer of LTE. If the required sequence number (SN) space for the handover is sufficient, the apparatus includes means for re-numbering the NR PDCP PDUs that need to be transmitted starting at 0 and storing the NR PDCP PDUs in the LTE PDCP transmission buffer. After the handover is completed, the apparatus includes means for transmitting the NR PDCP PDU before transmitting any new PDCP SDU.

Another embodiment is directed to a computer program embodied on a non-transitory computer readable medium. The computer program is configured to control a processor to perform, when handover from a new radio (NR) network to a long term evolution (LTE) network is triggered, a process that includes, if a required sequence number (SN) space for the handover is not sufficient in LTE, queueing the protocol data units (PDUs) from the packet data convergence protocol (PDCP) packet data unit (PDU) transmission buffer of new radio (NR) in the PDCP service data unit (SDU) transmission buffer of LTE. If the required sequence number (SN) space for the handover is sufficient, the process includes re-numbering the NR PDCP PDUs that need to be transmitted starting at 0 and storing the NR PDCP PDUs in the LTE PDCP transmission buffer. After the handover is completed, the process includes transmitting, by a transmitting entity, the NR PDCP PDU before transmitting any new PDCP SDU.

### BRIEF DESCRIPTION OF THE DRAWINGS

For proper understanding of the invention, reference should be made to the accompanying drawings, wherein:

FIG. 1 illustrates an example of the PDCP-Config information element;

FIG. 2 illustrates a block diagram depicting an example of the buffering of NR PDCP PDUs, according to an embodiment;

FIG. 3 illustrates a block diagram depicting an example of the out of order NR PDU treatment, according to an embodiment;

FIG. 4 illustrates a block diagram depicting the mapping of the NR PDCP transmission buffer to the LTE PDCP transmission buffer, according to an embodiment;

FIG. 5 illustrates a block diagram depicting an example of the merging of two bearers, according to an embodiment;

FIG. 6 illustrates a block diagram of an apparatus, according to one embodiment; and

FIG. 7 illustrates an example flow chart of a method, according to an embodiment.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products of signalling support for protocol data unit (PDU) handling for new radio (NR) to LTE handover, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

During a handover, the 3GPP LTE specifications provide that the packet data convergence protocol (PDCP) is in charge of re-transmitting the PDCP protocol data unit (PDU) in the PDCP buffer that have not been transmitted prior to handover. In particular, 3GPP technical specification (TS) 36.300 states: “The source eNB sends the SN STATUS TRANSFER message to the target eNB to convey the uplink PDCP SN receiver status and the downlink PDCP SN transmitter status of E-RABs for which PDCP status preservation applies (i.e. for RLC AM). The uplink PDCP SN receiver status includes at least the PDCP SN of the first missing UL SDU and may include a bit map of the receive status of the out of sequence UL SDUs that the UE needs to retransmit in the target cell, if there are any such SDUs. The downlink PDCP SN transmitter status indicates the next PDCP SN that the target eNB shall assign to new SDUs, not having a PDCP SN yet. The source eNB may omit sending this message if none of the E-RABs of the UE shall be treated with PDCP status preservation.”

However, when a Radio Bearer from new radio or new radio access technology (NR) is handed over to LTE, the PDCP layers may not be completely compatible. For example, the size of sequence number (SN) could be larger than the maximum allowed in LTE. In this case, the LTE PDCP transmission entity cannot use its buffer to store the PDCP PDU that need to be retransmitted in order to perform lossless handover and guaranty in-order delivery. Another possible scenario is a NR to 4G handover during which 2 data radio bearer (DRB) on the NR side will be grouped into 1 DRB on the LTE side. As such, the PDCP sublayer in LTE would not be able to mix the 2 buffers to re-transmit the missing PDUs.

The current LTE PDCP specification, 3GPP TS 36.323, provides the following: “When upper layers request a PDCP re-establishment, the UE shall: . . . from the first PDCP SDU for which the successful delivery of the corresponding PDCP PDU has not been confirmed by lower layers, perform retransmission or transmission of all the PDCP SDUs already associated with PDCP SNs in ascending order of the COUNT values associated to the PDCP SDU prior to the PDCP re-establishment as specified below: . . . submit the resulting PDCP Data PDU to lower layer.” This approach assumes that PDCP entities are compatible before and after the handover. However, the current RRC specification (3GPP TS 36.331) precludes changing the PDCP SN at handover.

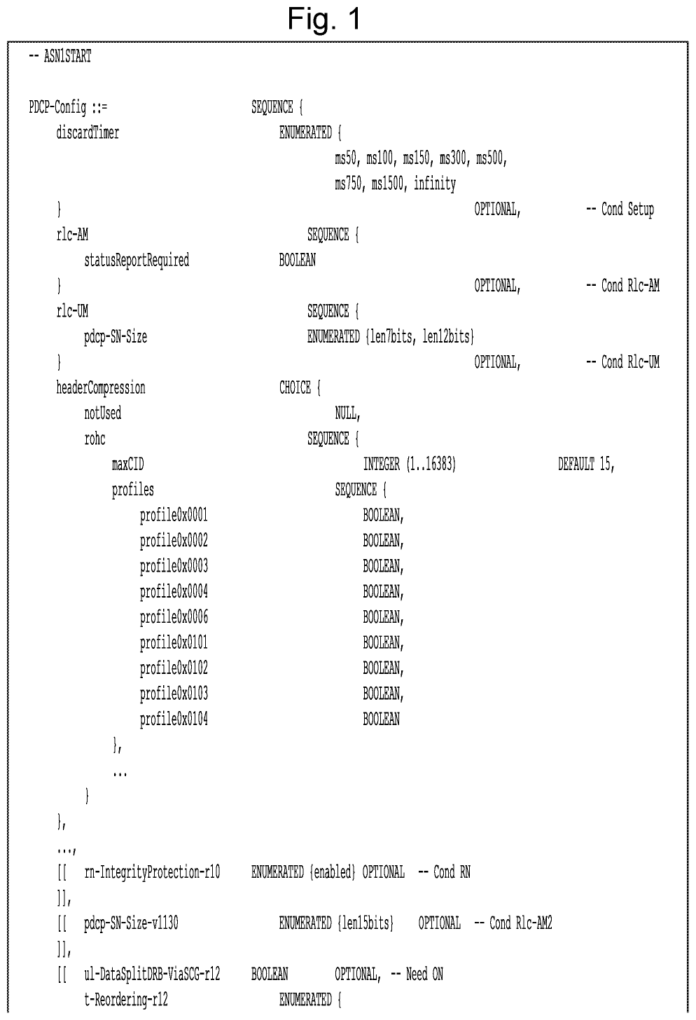

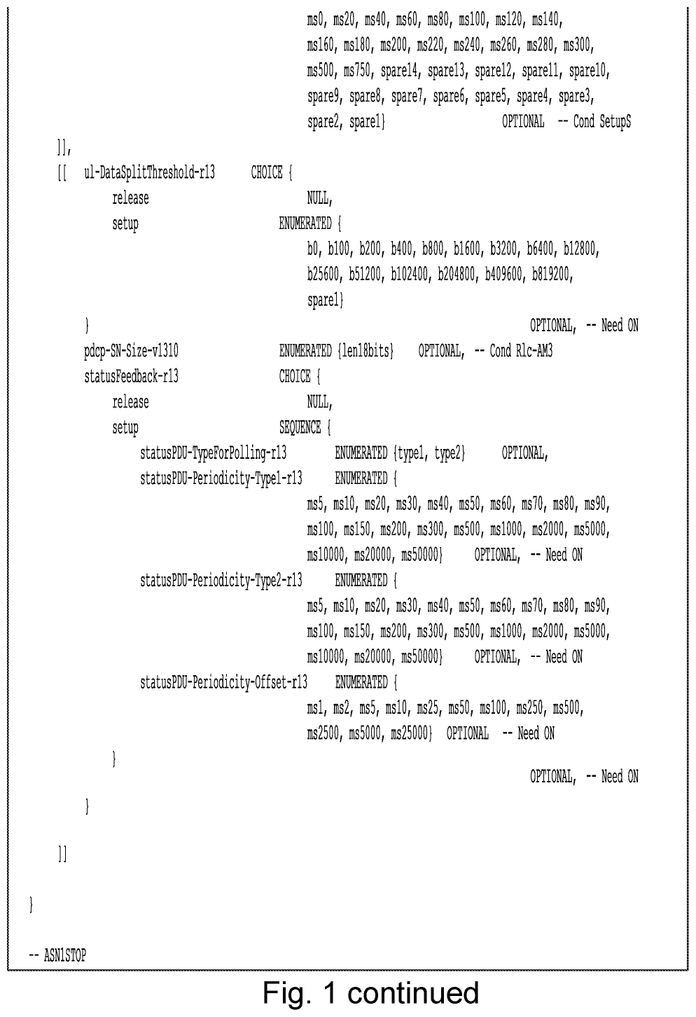

The information element (IE) PDCP-Config is used to set the configurable PDCP parameters for data radio bearers. FIG. 1 illustrates the PDCP-Config information element, and Table 1 below explains the PDCP-Config field descriptions.

TABLE 1
PDCP-Config field descriptions
discard Timer
Indicates the discard timer value specified in TS 36.323 [8]. Value in milliseconds. Value m550 means 50 ms,
ms100 means 100 ms and so on.
headerCompression
E-UTRAN does not reconfigure header compression for an MCG DRB except for upon handover and upon the
first reconfiguration after RRC connection re-establishment. E-UTRAN does not reconfigure header
compression for a SCG DRB except for upon SCG change involving PDCP re-establishment. For split and
LWA DRBs E-UTRAN configures only notUsed.
maxCID
Indicates the value of the MAX_CID parameter as specified in TS 36.323 [8]. The total value of MAX_CIDs
across all bearers for the UE should be less than or equal to the value of maxNumberROHC-ContextSessions
parameter as indicated by the UE.
pdcp-SN-Size
Indicates the PDCP Sequence Number length in bits. For RLC UM: value len7bits means that the 7-bit PDCP
SN format is used and len12bits means that the 12-bit PDCP SN format is used. For RLC AM: value len15bits
means that the 15-bit PDCP SN format is used, value len18bits means that the 18-bit PDCP SN format is
used, otherwise if the field is not included upon setup of the PCDP entity 12-bit PDCP SN format is used, as
specified in TS 36.323 [8].
profiles
The profiles used by both compressor and decompressor in both UE and E-UTRAN. The field indicates which
of the ROHC profiles specified in TS 36.323 [8]are supported, i.e. value true indicates that the profile is
supported. Profile 0x0000 shall always be supported when the use of ROHC is configured. If support of two
ROHC profile identifiers with the same 8 LSB′s is signalled, only the profile corresponding to the highest value
shall be applied. E-UTRAN does not configure ROHC while t-Reordering is configured (i.e. for split DRBs or
upon reconfiguration from split to MCG DRB).
statusFeedback
Indicates whether the UE shall send PDCP Status Report periodically or by E-UTRAN polling as specified in
TS 36.323 [8].
statusPDU-TypeForPolling
Indicates the PDCP Control PDU option when it is triggered by E-UTRAN polling. Value type1 indicates using
the legacy PDCP Control PDU for PDCP status reporting and value type2 indicates using the LWA specific
PDCP Control PDU for LWA status reporting as specified in TS 36.323 [8].
statusPDU-Periodicity-Type1
Indicates the value of the PDCP Status reporting periodicity for type1 Status PDU, as specified in TS 36.323
[8]. Value in milliseconds. Value m55 means 5 ms, ms10 means 10 ms and so on.
statusPDU-Periodicity-Type2
Indicates the value of the PDCP Status reporting periodicity for type2 Status PDU, as specified in TS 36.323
[8]. Value in milliseconds. Value m55 means 5 ms, ms10 means 10 ms and so on.
statusPDU-Periodicity-Offset
Indicates the value of the offset for type2 Status PDU periodicity, as specified in TS 36.323 [8]. Value in
milliseconds. Value ms1 means 1 ms, m52 means 2 ms and so on.
t-Reordering
Indicates the value of the reordering timer, as specified in TS 36.323 [8]. Value in milliseconds. Value ms0
means 0 ms, ms20 means 20 ms and so on.
rn-IntegrityProtection
Indicates that integrity protection or verification shall be applied for all subsequent packets received and sent
by the RN on the DRB.
statusReportRequired
Indicates whether or not the UE shall send a PDCP Status Report upon re-establishment of the PDCP entity
and upon PDCP data recovery as specified in TS 36.323 [8].
ul-DataSplitDRB-ViaSCG
Indicates whether the UE shall send PDCP PDUs via SCG as specified in TS 36.323 [8]. E-UTRAN only
configures the field (i.e. indicates value TRUE) for split DRBs.
ul-DataSplitThreshold
Indicates the threshold value for uplink data split operation specified in TS 36.323 [8]. Value b100 means 100
Bytes, b200 means 200 Bytes and so on. E-UTRAN only configures this field for split DRBs.

| Conditional | |
|---|---|
| presence | Explanation |
| Ric-AM | The field is mandatory present upon setup of a PDCP entity for a radio bearer configured |
| | with RLC AM. The field is optional, need ON, in case of reconfiguration of a PDCP entity |
| | at handover, at the first reconfiguration after RRC re-establishment or at SCG change |
| | involving PDCP re-establishment or PDCP data recovery for a radio bearer configured |
| | with RLC AM. Otherwise the field is not present. |
| Ric-AM2 | The field is optionally present, need OP, upon setup of a PDCP entity for a radio bearer |
| | configured with RLC AM. Otherwise the field is not present. |
| Ric-AM3 | The field is optionally present, need OP, upon setup of a PDCP entity for a radio bearer |
| | configured with RLC AM, if pdcp-SN-Size-v1130 is absent. Otherwise the field is not |
| | present. |
| Ric-UM | The field is mandatory present upon setup of a PDCP entity for a radio bearer configured |
| | with RLC UM. It is optionally present, Need ON, upon handover within E-UTRA, upon the |
| | first reconfiguration after re-establishment and upon SCG change involving PDCP re- |
| | establishment. Otherwise the field is not present. |
| RN | The field is optionally present when signalled to the RN, need OR. Otherwise the field is |
| | not present. |
| Setup | The field is mandatory present in case of radio bearer setup. Otherwise the field is |
| | optionally present, need ON. |
| SetupS | The field is mandatory present in case of setup of or reconfiguration to a split DRB or |
| | LWA DRB. The field is optionally present upon reconfiguration of a split DRB or LWA |
| | DRB or upon DRB type change from split to MCG DRB or from LWA to LTE only, need |
| | ON. Otherwise the field is not present. |

Certain embodiments of the invention relate to the handover of acknowledged mode (AM) data radio bearer(s) (DRB(s)) from a NR network to a LTE network and may cover at least two aspects including, for example, dealing with different sequence numbers (SNs) and with different number of radio bearers (RBs).

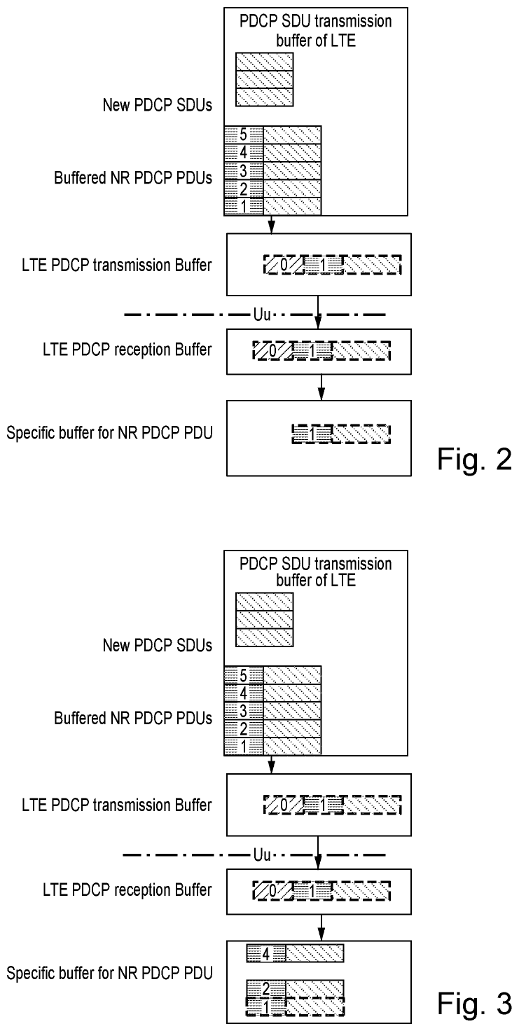

According to an embodiment, when handover is triggered (e.g., from NR network to LTE network) and when the SN space required for lossless handover is too small in LTE, the PDUs from the PDCP PDU transmission buffer of NR are queued in the PDCP SDU transmission buffer of LTE. The PDU keeps the NR PDCP header and SN. FIG. 2 illustrates a block diagram depicting an example of the buffering of NR PDCP PDUs, according to this embodiment. As illustrated in FIG. 2, when the handover is triggered, the NR PDCP PDU that need to be retransmitted in the NR PDCP transmission buffer are buffered prior to LTE PDCP buffer.

Optionally, in an embodiment at the receiving entity, the out-of-order NR PDCP PDU from the NR PDCP reception buffer are stored in a specific reception buffer for NR PDCP PDUs. FIG. 3 illustrates a block diagram depicting an example of the out of order NR PDU treatment, according to an embodiment. As illustrated in FIG. 3, the receiving entity may store, in a specific NR PDCP re-ordering buffer, the out-of-order NR PDCP PDU that it has already received. The PDU keeps the NR PDCP header and SN.

In certain embodiments, after the handover is completed, the PDCP transmitting entity in LTE transmits the NR PDCP PDU before transmitting any new PDCP SDU. Thus, after the completion of the handover procedure, the PDCP transmitting entity may submit, in order, the NR PDCP PDU, for example using a LTE PDCP header on top of the existing NR PDCP header. According to one embodiment, the LTE PDCP header may include an indication that it contains NR PDCP PDU. Once the transmission of remaining NR PDCP PDU is completed, the transmitting entity may transmit the new PDCP SDU.

In an embodiment, the receiving PDCP entity may detect that the received LTE PDCP SDU includes a NR PDCP PDU. In this case, it handles it as a NR PDCP PDU and stores it in the specific NR PDCP buffer. The receiving PDCP entity may then deliver the stored NR PDCP PDU in order to higher layers. Once the receiving PDCP entity receives a PDU that does not include NR PDCP PDU, this is interpreted to mean that all the NR PDCP PDU have been successfully transmitted and the receiving entity resumes normal operation.

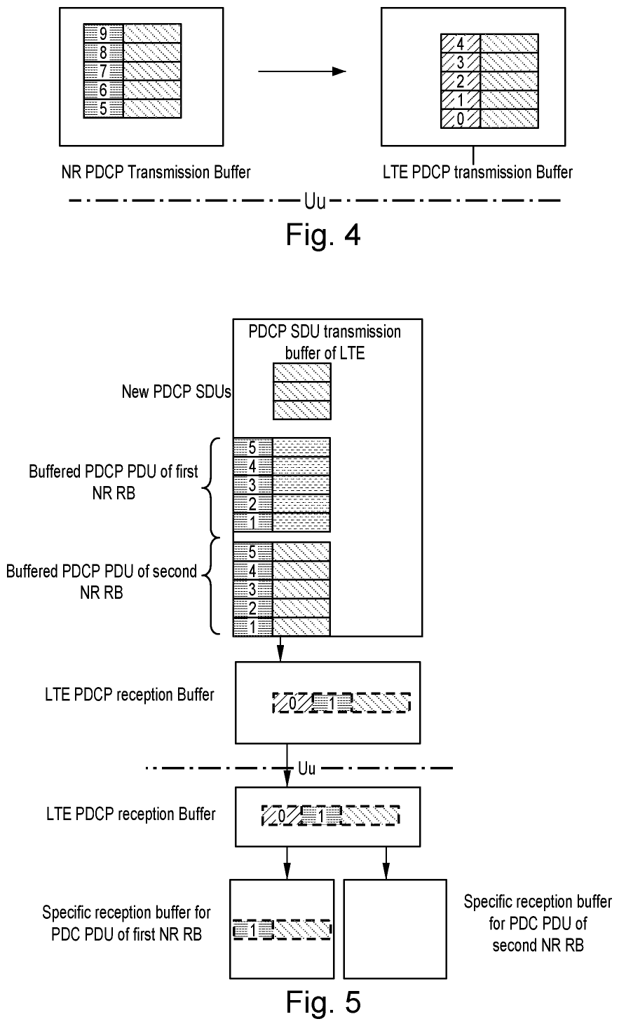

According to another embodiment, when the SN space required for lossless handover is sufficient but the SN numbers in NR are outside of SN space of LTE, the PDU in the transmission buffer are re-numbered, for example starting from 0. In other words, if the number of SN required for the buffered NR PDU PDCP is lower than the LTE PDCP window size, then the transmission PDCP entity may re-number the NR PDCP PDUs that need to be (re)transmitted starting at 0, and store them in the LTE PDCP transmission buffer. FIG. 4 illustrates a block diagram depicting the mapping of the NR PDCP transmission buffer to the LTE PDCP transmission buffer, according to this embodiment. The receiving entity in this case does not keep any PDU in its buffer.

In yet another embodiment, when 2 NR bearers are mapped to a single bearer in LTE when handover is triggered, the PDUs in the PDCP transmission buffer of the first NR bearer may be queued in the PDCP SDU transmission buffer of LTE. The PDUs in the PDCP transmission buffer of the second NR bearer may be queued in the PDCP SDU transmission buffer of LTE. The PDUs keep the NR PDCP header and SN.

FIG. 5 illustrates a block diagram depicting an example of the merging of two bearers, according to an embodiment. As illustrated in FIG. 5, when the handover is triggered, for both NR bearer, the NR PDCP PDU that need to be (re)transmitted are queued in the PDCP SDU transmission buffer of LTE. For example, in an embodiment, the PDUs in the PDCP transmission buffer of the first NR bearer may be queued in the PDCP SDU transmission buffer of LTE and the PDUs in the PDCP transmission buffer of the second NR bearer may be queued in the PDCP SDU transmission buffer of LTE. The PDUs keep the NR PDCP header and SN.

Optionally, according to an embodiment, in the receiving entity the out-of-order NR PDCP PDU from the NR PDCP reception buffer are stored in a specific reception buffer for NR PDCP PDUs. In this embodiment, the receiving entity may store in the two specific NR PDCP re-ordering buffer the out-of-order NR PDCP PDUs that it has already received. The PDU keep the NR PDCP header and SN from the respective PDCP layer of NR bearers.

When the handover is completed, the transmitting entity may send first the stored NR PDCP PDUs from the first NR RB, then the stored PDCP PDUs from the second RB. Thus, after the handover is completed, the transmitting PDCP entity may transmit in order all the PDCP PDU from first NR bearer using a LTE PDCP header on top of the existing one. The LTE PDCP header may include an indication that it contains NR PDCP PDU. Then, the transmitting entity may transmit in order all the PDCP PDU from second NR bearer using a LTE PDCP header on top of the existing one. The transmitting entity may then transmit the new PDCP SDU (that results from the merge of the two bearers). It is noted that, according to this embodiment, the RLC layer provides in order delivery of the PDUs, over the air.

In an embodiment, the receiving entity may deliver the NR PDCP PDU to higher layers, in order of NR PDCP SN for each NR RB. For example, in this embodiment, the receiving PDCP entity may receive the LTE PCP PDU and detect if the received LTE PDCP SDU includes a NR PDCP PDU. In this case, the receiving entity handles it as a NR PDCP PDU. If it is a PDCP PDU from first NR bearer, it is stored in the specific reception buffer for PDC PDU of first NR bearer. If it is a PDCP PDU from second NR bearer, it is stored in the specific reception buffer for PDC PDU of second NR RB. The receiving PDCP entity may then deliver the PDCP PDU of first NR bearer in order to higher layers, and may deliver the PDCP PDU of second NR bearer in order to higher layers. Once the receiving LTE PDCP entity detects that it receives a PDU that does not include PDCP PDU of first or second NR bearer, the receiving entity resumes normal operation.

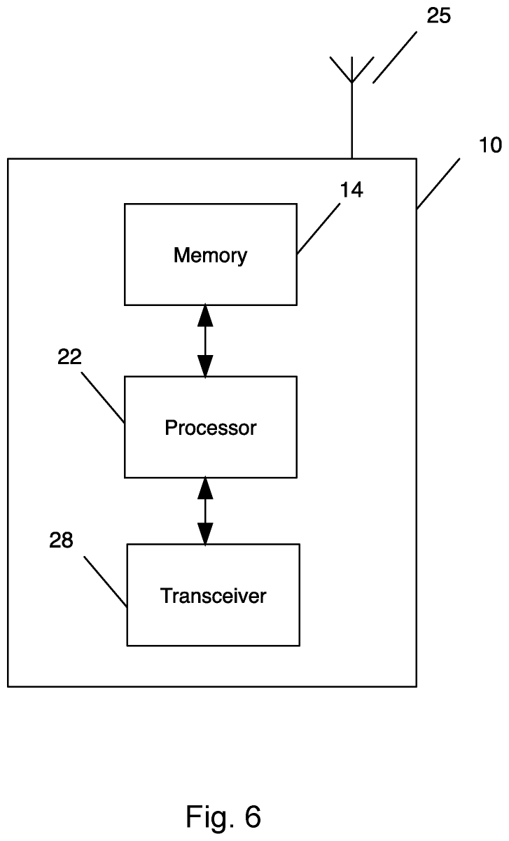

FIG. 6 illustrates an example of an apparatus 10 according to an embodiment. In an embodiment, apparatus 10 may be a node, host, or server in a communications network or serving such a network. For example, apparatus 10 may be a network node or access node for a radio access network, such as a base station, node B or eNB, or an access node of 5G or new radio access technology. Thus, in certain embodiments, apparatus 10 may include a base station, access node, node B or eNB serving a cell. It should be noted that one of ordinary skill in the art would understand that apparatus 10 may include components or features not shown in FIG. 6.

As illustrated in FIG. 6, apparatus 10 may include a processor 22 for processing information and executing instructions or operations. Processor 22 may be any type of general or specific purpose processor. While a single processor 22 is shown in FIG. 6, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of LTE, WLAN, Bluetooth, BT-LE, NFC, radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink). As such, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In one embodiment, apparatus 10 may be a network node or access node, such as a base station, node B or eNB, or an access node of 5G or NR, for example. According to one embodiment, apparatus 10 may be controlled by memory 14 and processor 22 to perform the functions associated with embodiments described herein. For instance, in an embodiment, when handover is triggered (e.g., from a 5G (NR) system to a 4G (LTE) system), apparatus 10 may be controlled by memory 14 and processor 22 to, if the SN space required for lossless handover is too small in LTE, store or queue the PDUs in the PDCP PDU transmission buffer of NR in the PDCP SDU transmission buffer of LTE. As a result, the NR PDCP PDU that need to be retransmitted in the NR PDCP transmission buffer are buffered prior to LTE PDCP buffer. When the SN space required for lossless handover is sufficient but the SN numbers in NR are outside of SN space of LTE, apparatus 10 may be controlled by memory 14 and processor 22 to re-number the PDU in the transmission buffer, starting from 0.

According to an embodiment, when two NR bearers are mapped to a single bearer in LTE during the handover, apparatus 10 may be controlled by memory 14 and processor 22 to store or queue the PDUs in the PDCP transmission buffer of the first NR bearer in the PDCP SDU transmission buffer of LTE, and to store or queue the PDUs in the PDCP transmission buffer of the second NR bearer in the PDCP SDU transmission buffer of LTE. The PDUs keep the NR PDCP header and SN. After the handover is completed, apparatus 10 may be controlled by memory 14 and processor 22 to transmit the NR PDCP PDU, before transmission of any new PDCP SDU. The LTE PDCP header may include an indication that it contains NR PDCP PDU. The receiving (PDCP) entity may detect that the received LTE PDCP SDU includes a NR PDCP SDU. In this case, the receiving entity handles it as a NR PDCP PDU and stores it in the specific NR PDCP Buffer. The stored NR PDCP PDU are then delivered in order to higher layers.

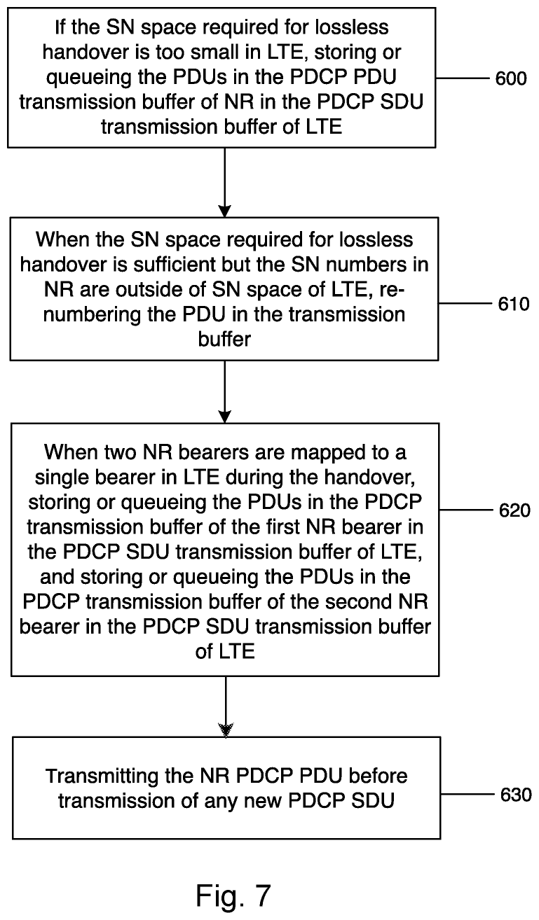

FIG. 7 illustrates an example of a flow chart for a method, according to one embodiment. In certain embodiments, the method depicted in FIG. 7 may be performed by a network node, such as a base station or eNB, for example. As illustrated in FIG. 7, when handover is triggered (e.g., from a 5G (NR) system to a 4G (LTE) system), the method may include, at 600, determining if the SN space required for lossless handover is too small in LTE and, if so, storing or queueing the PDUs in the PDCP PDU transmission buffer of NR in the PDCP SDU transmission buffer of LTE. As a result, the NR PDCP PDU that need to be retransmitted in the NR PDCP transmission buffer are buffered prior to LTE PDCP buffer. When it is determined that the SN space required for lossless handover is sufficient but the SN numbers in NR are outside of SN space of LTE, the method may include, at 610, re-numbering the PDU in the transmission buffer, e.g., starting from 0.

In certain embodiments, when two NR bearers are mapped to a single bearer in LTE during the handover, the method of FIG. 7 may further include, at 620, storing or queueing the PDUs in the PDCP transmission buffer of the first NR bearer in the PDCP SDU transmission buffer of LTE, and storing or queueing the PDUs in the PDCP transmission buffer of the second NR bearer in the PDCP SDU transmission buffer of LTE. The PDUs keep the NR PDCP header and SN. After the handover is completed, the method may include, at 630, transmitting the NR PDCP PDU before transmission of any new PDCP SDU to, for example, a receiving PDCP entity or target eNB. The LTE PDCP header may include an indication that it contains NR PDCP PDU. The receiving (PDCP) entity may detect that the received LTE PDCP SDU includes a NR PDCP SDU. In this case, the receiving entity handles it as a NR PDCP PDU and stores it in the specific NR PDCP Buffer. The stored NR PDCP PDU are then delivered in order to higher layers.

Embodiments of the invention provide several advantages and/or technical improvements. For example, embodiments of the invention can improve performance and throughput of network nodes including, for example, eNBs and UEs. In particular, embodiments of the invention allow for lossless mobility between LTE and NR regardless of the number of bearers and the SN configuration in term of SN. As a result, the use of embodiments of the invention result in improved functioning of communications networks and their nodes.

In some embodiments, the functionality of any of the methods, processes, signaling diagrams, or flow charts described herein may be implemented by software and/or computer program code or portions of code stored in memory or other computer readable or tangible media, and executed by a processor. In some embodiments, the apparatus may be, included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-13. (canceled)

14. A method, comprising:
when handover from a new radio (NR) network to a long term evolution (LTE) network is triggered, if a required sequence number (SN) space for the handover is not sufficient in LTE, queueing the protocol data units (PDUs) from the packet data convergence protocol (PDCP) packet data unit (PDU) transmission buffer of new radio (NR) in the PDCP service data unit (SDU) transmission buffer of LTE;
if the required sequence number (SN) space for the handover is sufficient, re-numbering the NR PDCP PDUs that need to be transmitted starting at 0 and storing the NR PDCP PDUs in the LTE PDCP transmission buffer; and
after the handover is completed, transmitting, by a transmitting entity, the NR PDCP PDU before transmitting any new PDCP SDU.

15. The method according to claim 14, further comprising, after completion of the handover, submitting in order the NR PDCP PDU using a LTE PDCP header, wherein the LTE PDCP header comprises an indication that it contains NR PDCP PDU.

16. The method according to claim 14, further comprising, when the transmitting of remaining NR PDCP PDU is completed, transmitting the new PDCP SDU.

17. The method according to claim 14, wherein, when a receiving entity detects that the LTE PDCP SDU includes a NR PDCP PDU, the receiving entity handles the LTE PDCP PDU as a NR PDCP PDU, stores the LTE PDCP PDU in the NR PDCP buffer, and delivers the stored NR PDCP PDU in order to higher layers.

18. The method according to claim 14, wherein, when two NR bearers are mapped to a single bearer in LTE during the handover, the method further comprises:
queueing the PDUs in the PDCP transmission buffer of a first of the two NR bearers in the PDCP SDU transmission buffer of LTE, and queueing the PDUs in the PDCP transmission buffer of a second of the two NR bearers in the PDCP SDU transmission buffer of LTE.

19. The method according to claim 18, further comprising:
transmitting the queued NR PDCP PDUs from the first NR bearer first, then the queued PDCP PDUs from the second NR bearer.

20. An apparatus, comprising:
at least one processor; and
at least one memory including computer program code,
wherein the at least one memory and computer program code are configured, with the at least one processor, to cause the apparatus at least to
when handover from a new radio (NR) network to a long term evolution (LTE) network is triggered,
if a required sequence number (SN) space for the handover is not sufficient in LTE, queue the protocol data units (PDUs) from the packet data convergence protocol (PDCP) packet data unit (PDU) transmission buffer of new radio (NR) in the PDCP service data unit (SDU) transmission buffer of LTE;
if the required sequence number (SN) space for the handover is sufficient, re-number the NR PDCP PDUs that need to be transmitted starting at 0 and storing the NR PDCP PDUs in the LTE PDCP transmission buffer; and
after the handover is completed, transmit the NR PDCP PDU before transmitting any new PDCP SDU.

21. The apparatus according to claim 20, wherein the at least one memory and computer program code are further configured, with the at least one processor, to cause the apparatus at least to, after completion of the handover, submit in order the NR PDCP PDU using a LTE PDCP header, wherein the LTE PDCP header comprises an indication that it contains NR PDCP PDU.

22. The apparatus according to claim 20, wherein the at least one memory and computer program code are further configured, with the at least one processor, to cause the apparatus at least to, when the transmitting of remaining NR PDCP PDU is completed, transmit the new PDCP SDU.

23. The apparatus according to claim 20, wherein, when a receiving entity detects that the LTE PDCP SDU includes a NR PDCP PDU, the receiving entity handles the LTE PDCP PDU as a NR PDCP PDU, stores the LTE PDCP PDU in the NR PDCP buffer, and delivers the stored NR PDCP PDU in order to higher layers.

24. The apparatus according to claim 20, wherein, when two NR bearers are mapped to a single bearer in LTE during the handover, the at least one memory and computer program code are further configured, with the at least one processor, to cause the apparatus at least to:
queue the PDUs in the PDCP transmission buffer of a first of the two NR bearers in the PDCP SDU transmission buffer of LTE, and queue the PDUs in the PDCP transmission buffer of a second of the two NR bearers in the PDCP SDU transmission buffer of LTE.

25. The apparatus according to claim 24, wherein, when NR PDCP PDUs are queued in the PDCP SDU transmission buffer of LTE, the at least one memory and computer program code are further configured, with the at least one processor, to cause the apparatus at least to:
transmit the queued NR PDCP PDUs from the first NR bearer first, then the queued PDCP PDUs from the second NR bearer.

26. The apparatus according to claim 20, wherein the apparatus comprises an evolved node B.

27. A computer program embodied on a non-transitory computer readable medium, the computer program configured to control a processor to perform:
when handover from a new radio (NR) network to a long term evolution (LTE) network is triggered,
if a required sequence number (SN) space for the handover is not sufficient in LTE, queueing the protocol data units (PDUs) from the packet data convergence protocol (PDCP) packet data unit (PDU) transmission buffer of new radio (NR) in the PDCP service data unit (SDU) transmission buffer of LTE;
if the required sequence number (SN) space for the handover is sufficient, re-numbering the NR PDCP PDUs that need to be transmitted starting at 0 and storing the NR PDCP PDUs in the LTE PDCP transmission buffer; and
after the handover is completed, transmitting, by a transmitting entity, the NR PDCP PDU before transmitting any new PDCP SDU.

28. The computer program according to claim 27, further comprising, after completion of the handover, submitting in order the NR PDCP PDU using a LTE PDCP header, wherein the LTE PDCP header comprises an indication that it contains NR PDCP PDU.

29. The computer program according to claim 27, further comprising, when the transmitting of remaining NR PDCP PDU is completed, transmitting the new PDCP SDU.

30. The computer program according to claim 27, wherein, when a receiving entity detects that the LTE PDCP SDU includes a NR PDCP PDU, the receiving entity handles the LTE PDCP PDU as a NR PDCP PDU, stores the LTE PDCP PDU in the NR PDCP buffer, and delivers the stored NR PDCP PDU in order to higher layers.

31. The computer program according to claim 27, wherein, when two NR bearers are mapped to a single bearer in LTE during the handover, further configured to control the processor to perform:
queueing the PDUs in the PDCP transmission buffer of a first of the two NR bearers in the PDCP SDU transmission buffer of LTE, and queueing the PDUs in the PDCP transmission buffer of a second of the two NR bearers in the PDCP SDU transmission buffer of LTE.

32. The computer program according to claim 31, further configured to control the processor to perform:
transmitting the queued NR PDCP PDUs from the first NR bearer first, then the queued PDCP PDUs from the second NR bearer.
